(19) United States
(12) Patent Application Publication
(10) Pub. No.: US 2018/0050475 A1
(43) Pub. Date: Feb. 22, 2018

(54) AUTOMATIC PORTABLE PLASTIC INJECTION MACHINE

(71) Applicant: APSX LLC, Cincinnati, OH (US)

(72) Inventors: Hasan Kubilay Kara, Blue Ash, OH (US); Burak Cevik, Cincinnati, OH (US)

(73) Assignee: APSX LLC, Cincinnati, OH (US)

(21) Appl. No.: 15/682,028

(22) Filed: Aug. 21, 2017

Related U.S. Application Data
(60) Provisional application No. 62/376,979, filed on Aug. 19, 2016.

(51) Int. Cl. B29C 45/00; B29C 45/17; B29C 45/18; B29C 45/26; B29C 45/58; B29C 45/62; B29C 45/64; B29C 45/76

(52) U.S. Cl. CPC B29C 45/0001; B29C 45/1706; B29C 45/18; B29C 45/261; B29C 45/2642; B29C 45/586; B29K 2101/12; B29C 45/641; B29C 45/76; B29C 2045/1707; B29C 2045/1709; B29C 2045/1825; B29C 45/62

(57) ABSTRACT

In a plastic injection machine, a controller in electrical communication with a motorized clamp assembly, a heated cylinder barrel, a motorized pre-plasticizing assembly, an injection assembly, and an air mover and that executes an application that configures the controller to: (i) feed thermoplastic material into a heated cylinder barrel that is closed at one end by an injection valve; (ii) warm the heated cylinder barrel to thermoplastic material to a liquid state; (iii) actuate an injection motor to preload a spring biased plunger received within another end of the heated cylinder barrel, thereby pressurizing liquid thermoplastic material in the heating cylinder barrel to an injection pressure set value; (iv) actuate an injection valve motor to open the injection valve causing the pressurized liquid thermoplastic material to inject into a clamped mold; and (v) release a portion of the clamped mold to release the molded article.

### CLAIM OF PRIORITY UNDER 35 U.S.C. § 119

The present Application for Patent claims priority to Provisional Application No. 62/376,979 entitled “Full Automatic Portable Plastic Injection Machine for Prototyping and Low-Volume Production” filed 19 Aug. 2016, and assigned to the assignee hereof and hereby expressly incorporated by reference herein.

### BACKGROUND

### 1. Technical Field

The present disclosure relates in general to plastic injection molding machines.

### 2. Description of the Related Art

The injection molding of thermoplastic resins is a well-known and widely practiced application. It constitutes a major processing technique for converting plastics into a variety of end-use products. Basically, the process involves heating the solid pellets to melt, then transferring it to a mold and holding it under pressure until it freezes, or solidifies.

Plastic molding compounds represent a range of chemical types. Each type has its own specific processing characteristics which must be considered and understood before it can be successfully molded. Processing Characteristics: The physical and chemical properties of a plastic dictate the way in which it must be molded. Among these are: (a) Melting or softening temperature (b) Energy content (specific heat and latent heat); (c) Melt viscosity; (d) Stability and behavior at melt temperatures; (e) Freezing rate, crystallization rate, and cycle time; and (e) Shrinkage. Example for Polypropylene: For example the PP which is a frequently used plastic has physical, mechanical, impact and thermal properties listed. Specific gravity, mass flow rate, tensile strength, izod impact, deflection temperature under load are some of the properties that make a difference when processing for injection molding.

Some generally-known injection systems use a 2 or 3 phase 5 kilowatt motor power. Injection occurs within about 1 second to fill, requiring a significant hydraulic motor. To reduce the power requirement, some generally-known injection system accumulate energy into pressurized air in a concentrated fashion but it is complicated and expensive.

### BRIEF SUMMARY

According to illustrative embodiments of the present disclosure, a method is provided of injection molding thermoplastic articles with an injection molding machine. In one or more embodiments, the method includes feeding thermoplastic material into a heated cylinder barrel that is closed at one end by an injection valve. The method includes warming the heated cylinder barrel to transform thermoplastic material to a liquid state. The method includes actuating an injection motor to preload a spring biased plunger received within another end of the heated cylinder barrel, thereby pressurizing liquid thermoplastic material in the heating cylinder barrel to an injection pressure set value. The method includes actuating an injection valve motor to open the injection valve causing the pressurized liquid thermoplastic material to inject into a clamped mold. The method includes releasing a portion of the clamped mold to release the molded article.

In accordance with the teachings of the present disclosure, an injection molding machine includes a replaceable two-piece mold; a motorized clamp assembly that selectively opens and clamps shut the two-piece mold; an electrically-controlled injection valve in fluid communication with an interior cavity defined by the two-piece mold; a heated cylinder barrel having one end in communication with the interior cavity of the two-piece mold via the injection valve; a motorized pre-plasticizing assembly that selectively feeds solid thermoplastic material into the heated cylinder barrel; a injection assembly comprising: (i) a plunger that is received for movement in another end of the heated cylinder barrel; (ii) a spring biasing the plunger toward the heated cylinder barrel; and (iii) an injection motor that selects moves the spring between an unbiased home position and a biased forward position to impart potential energy in the spring; and a controller. The controller is in electrical communication with the motorized clamp assembly, the heated cylinder barrel, the motorized pre-plasticizing assembly, the injection assembly, and the air mover. The controller executes an application that configures the controller to: (a) feed thermoplastic material into a heated cylinder barrel that is closed at one end by an injection valve; (b) warm the heated cylinder barrel to thermoplastic material to a liquid state; (c) actuate an injection motor to preload a spring biased plunger received within another end of the heated cylinder barrel, thereby pressurizing liquid thermoplastic material in the heating cylinder barrel to an injection pressure set value; (d) actuate an injection valve motor to open the injection valve causing the pressurized liquid thermoplastic material to inject into a clamped mold; and (e) release a portion of the clamped mold to release the molded article.

The above presents a general summary of several aspects of the disclosure in order to provide a basic understanding of at least some aspects of the disclosure. The above summary contains simplifications, generalizations and omissions of detail and is not intended as a comprehensive description of the claimed subject matter but, rather, is intended to provide a brief overview of some of the functionality associated therewith. The summary is not intended to delineate the scope of the claims, and the summary merely presents some concepts of the disclosure in a general form as a prelude to the more detailed description that follows. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 illustrates a functional block diagram of an automated plastic injection molding machine, according to one or more embodiments;

FIG. 2 illustrates a right front isometric view of an example injection molding machine, according to one or more embodiments;

FIG. 3 illustrates a left bottom isometric view of the example injection molding machine of FIG. 2, according to one or more embodiments;

FIG. 4 illustrates a top view of the example injection molding machine of FIG. 2, according to one or more embodiments;

FIG. 5 illustrates a right side view of the example injection molding machine of FIG. 2, according to one or more embodiments;

FIG. 6 illustrates a left side view of the example injection molding machine of FIG. 2, according to one or more embodiments;

FIG. 7 illustrates an isometric view of a hopper screw of the example injection molding machine of FIG. 2, according to one or more embodiments;

FIG. 8 illustrates an isometric right view of a plastic handling portion of the example injection molding machine of FIG. 2, according to one or more embodiments;

FIG. 9 illustrates an isometric, disassembled view of the plastic handling portion of FIG. 8, according to one or more embodiments;

FIG. 10 illustrates an isometric right dispensing side view of a valve metal block of the plastic handling portion of FIG. 8, according to one or more embodiments;

FIG. 11 illustrates an isometric left intake side view of the valve metal block of FIG. 10, according to one or more embodiments;

FIG. 12 illustrates an isometric right side view of a cylinder barrel having an inserted torpedo nozzle of the plastic handling portion of FIG. 8, according to one or more embodiments;

FIG. 13 illustrates an isometric left upstream side view of the torpedo nozzle of FIG. 8, according to one or more embodiments;

FIG. 14 illustrates an isometric right downstream side view of the torpedo nozzle of FIG. 13, according to one or more embodiments;

FIG. 15 illustrates a depiction of a settings user interface of the of the example injection molding machine, according to one or more embodiments;

FIG. 16 illustrates a depiction of a component status user interface of the of the example injection molding machine, according to one or more embodiments;

FIG. 17 illustrates a depiction of a process user interface of the of the example injection molding machine, according to one or more embodiments;

FIG. 18 illustrates a depiction of a troubleshooting user interface of the of the exemplary injection molding machine, according to one or more embodiments;

FIG. 19 illustrates a flow diagram of a method of automatically injection molding of an article, according to one or more embodiments; and

FIG. 20 illustrates a flow diagram of an exemplary method of automatically injection molding of an article, according to one or more embodiments.

### DETAILED DESCRIPTION

According to aspect of the present disclosure, a machine and a method are provided that make plastic parts by using spring loaded injection pressure and electronically controlled plastic melting barrel. All machine assemblies such as pre-plasticizing, plasticizing, injection, injection valve, clamping and user interface are fully automatic and all parameters can be set and customized by the user. The devices and methods of the present invention enable the user to make plastic parts cost effectively and in-house in a repeatable, easy and user friendly way for the prototyping, testing, new product development and low-volume part production. The devices and methods of the present invention avoid air entrapment in the molten plastic, provides a high speed injection and reduces dead zones in the injection process that trap and degrade the material quality. The devices and methods of the present invention provide cost reduction, process time saving and agility to the part injection process. The devices and methods of the present invention consume much less energy and does not make high level noises as compared to generally-known injection processes by not requiring an air compressor or water cooling connections for cooling purposes. For the same reason, the apparatus of the current invention also operates in a clean way and can be placed in an office environment. The present innovation does not require high voltage line installation by using 115 VAC regular power voltage. The apparatus is not too heavy to be moved around, enabling placement in different facilities or rooms within a facility. Generally-known, conventional plastic injection machines are complex in design, maintenance intensive, bulky in size and relatively undesirable in environments of higher cleanliness.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that terms is utilized.

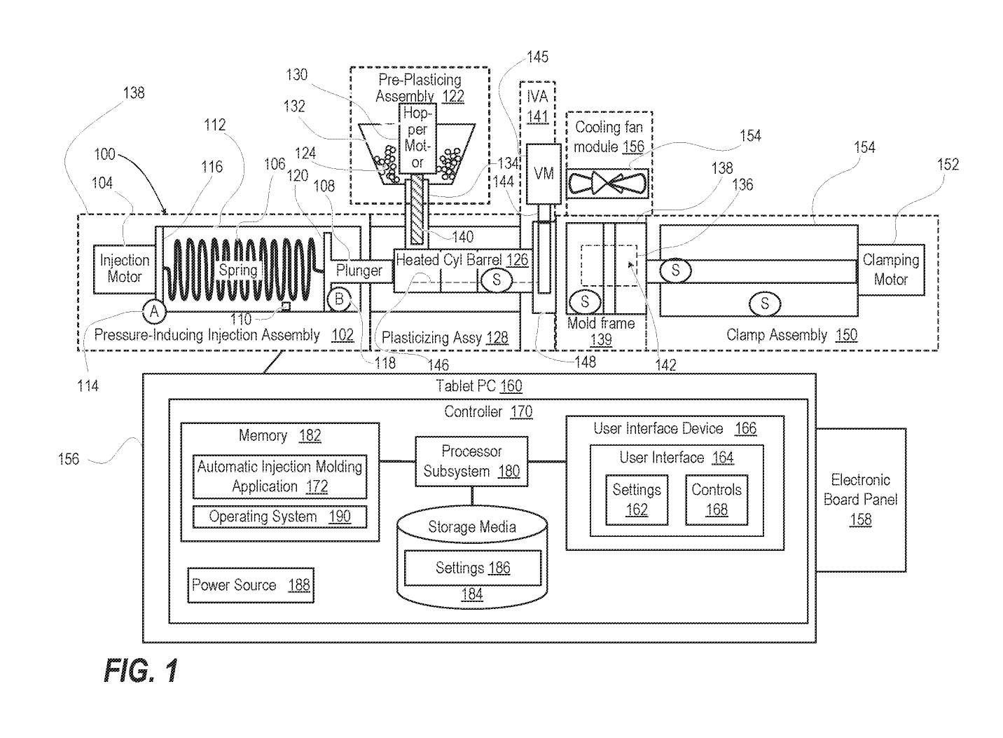

FIG. 1 illustrates a plastic injection machine 100 that includes a pressure-inducing injection assembly 102 that includes an injection motor 104, a compression spring 106, a plunger 108, a home position stop 110, and a cylindrical spring housing 112. The compression spring 106 is used for both creating a user-settable injection pressure and dynamically determining an amount of injected material in order to limit to a user-selected total amount. A position sensor “A” 114 is attached to an upstream plate 116 and a position sensor “B” 118 is attached to a downstream plate 120. The injection motor 104 acts on the upstream plate 116 to cause compression pressure to accumulate in the spring 106 that is between the upstream and downstream plates 116, 120. The sensors A, B 114, 118 are used to differentially measure the pressure supplied. The sensor B 118 on the plunger side will stop moving after initial push. Sensor A 114, on the upstream plate 116 on injection motor side, keeps moving as pressure increases. Based on predetermined characteristics of the spring 106, the positional difference can be used to calculate a spring force, which in turn is related to spatial contact of the plunger 108 against injection material to determine an injection pressure (e.g., a force in the range of approximately 1000 P.S.I. to approximately 6000 P.S.I.). When the incompressible liquid injection material is allowed to inject, sensor B 118 is used to measure translational movement of the plunger 108, from which a corresponding volume of injected injection material can be determined based upon predetermined cross sectional area of the injection material.

The plastic injection machine 100 includes a pre-plasticizing assembly 122 that allows the transfer of plastic pellets 124 into a heated cylinder barrel 126 of a plasticizing assembly 128. The pre-plasticizing assembly 122 includes a hopper motor 130, hopper 132 and hopper feeder 134. It also prevents the backward flow of pellets to the hopper feeder 134 when the injection plunger 108 injects the pellets into a mold cavity 136 of an injection mold kit 138 engageably received by a mold frame 139. Hopper feeder 134 with a hopper screw 140 can control the amount of metered plastic material, that begins as plastic pellets 124, to be transferred from the hopper 132. The plasticizing assembly 128 melts and maintains the plastic pellets 124 at a set temperature within the electrically-controlled heated cylinder barrel 126 in preparation for the injection procedure.

It is to be appreciated that sensors other than a pressure sensor can be employed to measure any other characteristics of the molten thermoplastic material, the plunger 108, the barrel 126, or the like that is known in the art, such as, temperature, viscosity, flow rate, strain, velocity, etc. or one or more of any other characteristics that are indicative of any of these.

Generally, plastic pellets (hereinafter referred simply as “pellets”) are made from plastics and other organic resins. The plastics may be selected from general-purpose resin, such as polypropylene and polyethylene; well-known resin such as engineering plastics, such as polyimide and polycarbonate; and may include reinforcing fibers, such as glass fibers, carbon fibers, bamboo fibers, and hemp fibers. In one embodiment, the plastics may include 10-50% reinforcing fibers.

A variety of thermoplastic materials can be used in the injection molding methods and devices of the disclosure. The thermoplastic material can be, for example, a polyolefin. Exemplary polyolefins include, but are not limited to, polypropylene, polyethylene, polymethylpentene, and polybutene-1. The thermoplastic material can also be, for example, a polyester. Exemplary polyesters include, but are not limited to, polyethylene terphthalate (PET). Other suitable thermoplastic materials include copolymers of polypropylene and polyethylene, and polymers and copolymers of thermoplastic elastomers, polyester, polystyrene, polycarbonate, poly(acrylonitrile-butadiene-styrene), poly(lactic acid), bio-based polyesters such as poly(ethylene furanate) polyhydroxyalkanoate, poly(ethylene furanoate), (considered to be an alternative to, or drop-in replacement for, PET), polyhydroxyalkanoate, polyamides, polyacetals, ethylene-alpha olefin rubbers, and styrene-butadiene-styrene block copolymers. The thermoplastic material can also be a blend of multiple polymeric and non-polymeric materials. The thermoplastic material can be, for example, a blend of high, medium, and low molecular polymers yielding a multi-modal or bi-modal blend. The multi-modal material can be designed in a way that results in a thermoplastic material that has superior flow properties yet has satisfactory chemo/physical properties. The thermoplastic material can also be a blend of a polymer with one or more small molecule additives. The small molecule could be, for example, a siloxane or other lubricating molecule that, when added to the thermoplastic material, improves the flowability of the polymeric material.

Other suitable thermoplastic materials include renewable polymers such as nonlimiting examples of polymers produced directly from organisms, such as polyhydroxyalkanoates (e.g., poly(beta-hydroxyalkanoate), poly(3-hydroxybutyrate-co-3-hydroxyvalerate, NODAX (Registered Trademark)), and bacterial cellulose; polymers extracted from plants, agricultural and forest, and biomass, such as polysaccharides and derivatives thereof (e.g., gums, cellulose, cellulose esters, chitin, chitosan, starch, chemically modified starch, particles of cellulose acetate), proteins (e.g., zein, whey, gluten, collagen), lipids, lignins, and natural rubber; thermoplastic starch produced from starch or chemically starch and current polymers derived from naturally sourced monomers and derivatives, such as bio-polyethylene, bio-polypropylene, polytrimethylene terephthalate, polylactic acid, NYLON 11, alkyd resins, succinic acid-based polyesters, and bio-polyethylene terephthalate.

In addition, in the present invention may include additive agents or components that improves quality or the process and product. Additive agents of the present invention include an additive agent that gives moldability and thermal stability when thermoplastic resin is molded, and an additive agent that improves durability under an environment where a thermoplastic resin molded product is used. Specifically, the following additive agents are included: a stabilizer (an antioxidant, a thermal degradation inhibitor, or a hydrolysis inhibitor); a light stabilizer; a UV absorber; a lubricant; a mold lubricant; a plasticizer; a slidability improver; a flame retardant; a foaming agent; an antistatic agent; a dispersing agent; a nucleating agent; a colorant; etc., and one or more kinds of these additive agents can be mixed and used.

In addition, as filling materials of the present invention, there are included filling materials for improving various characteristics, such as strength, rigidity, and heat resistance of the thermoplastic resin molded product, and they are usually used. Specifically, the following filling materials are exemplified: glass-based reinforcing agents, such as glass beads, glass flakes, and glass balloons; silicate-based reinforcing agents, such as talc, clay, mica, wollastonite, montmorillonite, magnesium silicate, and aluminum silicate; sulfate-based reinforcing agents, such as barium sulfate; carbonate-based reinforcing agents, such as calcium carbonate, magnesium carbonate, and zinc carbonate; hydroxide reinforcing agents, such as aluminum hydroxide, magnesium hydroxide, and calcium hydroxide; oxide reinforcing agents, such as silica, alumina, titanium oxide, antimony oxide, zinc oxide, magnesium oxide, calcium oxide, and silicon oxide; carbon-based reinforcing agents, such as carbon black, graphite, and carbon fibers; metal-based reinforcing agents, such as aluminum, copper, iron, boron, stainless fibers, powder, and flakes; silicon carbide; boron nitride; a potassium titanate whisker; an aluminum borate whisker; a coupling agent; an acid-modified resin binder agent; a rubber component; etc. In the present invention, one or more kinds of these filling materials can be mixed and used. In addition, particularly, in a case where the resin raw material is fed from the feed hole of the upstream side of the heating cylinder, and the additive components are fed from the feed hole of the downstream side thereof, a time for the additive components to receive heat in the screw groove can be reduced, and thus even additive components with low heat resistance, such as wood pulp, wastepaper, used paper, and wool can be uniformly dispersed in the molten resin while thermal degradation is suppressed.

In one or more embodiments, the hopper 132 and/or hopper feeder 134 may be actively cooled with a cooling liquid flowing or passively cooled through convection and conduction to the atmosphere. In one or more embodiments, the hopper 132 and/or hopper feeder 134 may incorporate an effective cooling surface. The term “effective cooling surface” is defined as a surface through which heat is removed from a part. One example of an effective cooling surface is a surface that defines a channel for cooling fluid from an active cooling system. Another example of an effective cooling surface is an outer surface of a part through which heat dissipates to the atmosphere. A mold part may have more than one effective cooling surface and thus may have a unique average thermal conductivity between the part surface and each effective cooling surface.

In an embodiment, the plasticizing assembly 128 and the injection assembly 102 are secured to a portable structure 138. Injection assembly 102 applies linear injection pressure onto the melted plastic within the plasticizing assembly 128 Injection assembly 102 uses the compression spring 106, injection motor 104 and the plunger 108. The plunger 108 is connected to the compression spring 106 by precision ball screw. Injection motor 104 compresses the compression spring 106 to push the plunger 108 into the cylinder barrel 126. The term “flow rate” generally refers to the volumetric flow rate of polymer as measured at the nozzle. This flow rate can be calculated based on the plunger travel rate and plunger cross sectional area, or measured with a suitable sensor located in the machine nozzle.

In one or more embodiments, an injection valve assembly 141 controls the flow of the pressurized melted plastic 142 into a plastic mold cavity 136. The injection valve assembly 141 includes a valve pin 144 and a valve motor 145 configured to control the flow of molten thermoplastic through the injection nozzle. Injection valve assembly 141 is connected to the tip of plasticizing assembly 128 with screws. The pressurized hot plastic 142 travels through the cylinder barrel 126 when the plunger 108 pushes the pressurized hot plastic 142 within a cylinder bore 146 along a flow path through the injection nozzle and into the mold cavity 136. The flow rate is adjustable for various plastics by electronically controlling the degree of opening angle of the valve pin 144 positioned in a metal valve block 148. In one or more embodiments, the valve pin 144 can be controlled by the valve motor 145 interconnected to the valve pin 144 through a sprocket mechanism.

In one embodiment, a melt pressure sensor (not shown) can facilitate detection (direct or indirect) of the actual melt pressure (e.g., the measured melt pressure) of the molten thermoplastic material, in, at, or near the nozzle. The melt pressure sensor may or may not be in direct contact with the molten thermoplastic material. In one embodiment, the melt pressure sensor can be a pressure transducer that transmits an electrical signal to an input of the control system in response to the melt pressure at the nozzle. In other embodiments, the melt pressure sensor can facilitate monitoring of any of a variety of additional or alternative characteristics of the molten thermoplastic material at the nozzle that might indicate melt pressure, such as temperature, viscosity, and/or flow rate, for example. If the melt pressure sensor is not located within the nozzle, the control system can be set, configured, and/or programmed with logic, commands, and/or executable program instructions to provide appropriate correction factors to estimate or calculate values for the measured characteristic in the nozzle.

A clamping assembly 150 holds the opposite injection pressure on the mold kit 138 by applying the force against the injection force generated by the injection assembly 102. The clamping assembly 150 can apply a clamping force in the range of approximately 1000 to approximately 6000 P.S.I. during the molding process to hold the mold kit 138 together in the clamped position. In one or more embodiments, the clamping force is in the range of approximately 1000 P.S.I. to approximately 16000 P.S.I.

The clamping assembly 150 uses similar sensing and position measurements to determine clamping force. In one or more embodiments, the clamping assembly 150 includes a clamping motor 152 and provides a mounting surface for air movers, such as cooling fans 154 of a cooling fan module 156. In one or more embodiments, four (4) thrust cylinders 154 close the injection mold kit 138 before injection and hold then open the injection mold kit 138 after injected parts have solidified.

User interface assembly 57 provides full control to the user. User interface assembly 157 has an electronics board panel 158 and a portable tablet personal computer (PC) 160. The electronic board panel 158 and the tablet PC 160 enable the user to set the operational and material related parameters on screen within the pre-set ranges.

A user of the plastic injection machine 100 powers the machine 100 from a regular 115V outlet and places the plastic pellets 124 within the hopper 132. After turning on the plastic injection machine 100, the user interface on the tablet PC 160 connected to the plastic injection machine 100 via USB cable becomes available for set up process. The user places and secures the injection mold kit 138 onto the plastic injection machine 100 and adjusts the ejector pins for a perfect ejection process. Once the user sets the desired injection temperature, part size, plastic material and other operational parameters on as setting affordances 162 enabled by a user interface 164 of a user interface device 166 such as a screen of the tablet PC 160, the heated cylinder barrel 126 gets heated by an installed heat element (not shown) which will create the transition from solid to liquid melt.

Once inside the heated cylinder barrel 126, the thermoplastic pellets 124 can be heated to above the melt temperature of the thermoplastic, which is generally between about 130 degrees C. to about 410 degrees C., and melted to form a molten thermoplastic material. The term “melt temperature” generally refers to the temperature of the polymer that is maintained in the cylinder bore 146, and in the material feed system in certain embodiments, which keeps the polymer in a molten state. The melt temperature varies by material, however, a desired melt temperature is generally understood to fall within the ranges recommended by the material manufacturer. After achieving the set temperature, the user starts the injection process by pushing a control affordance 168 such as a start button on a user interface 164 of the user interface device 166. The plastic injection machine 100 performs the injection molding functions of plasticizing, injection, clamping and ejection accordingly and completes the job as set by the user.

There can be alternative methods of embodying invention as described herein. The electric stepper motors can be servo or encoder integrated stepper motors. The portable tablet PC can be replaced by the mounted tablet PC. The hopper 132 can be fed either manually or automatically by using a pellet feeder mechanism.

The user interface assembly 157 can include functionality of a controller 170 for executing an automatic injection molding application 172. For purposes of this disclosure, controller 170, may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, a controller 170 may be a handheld device, personal computer, a server, a network storage device, or any other suitable device and may vary in size, shape, performance, functionality, and price. The controller 170 may include random access memory (RAM), one or more processing resources such as a central processing unit (CPU) or hardware or software control logic, ROM, and/or other types of nonvolatile memory. Additional components of the controller 170 may include one or more disk drives, one or more network ports for communicating with external devices as well as various input and output (I/O) devices, such as a keyboard, a mouse, and a video display. The controller 170 may also include one or more buses operable to transmit communications between the various hardware components.

In a particular embodiment, the controller 170 includes a processor 180, a memory 182 communicatively coupled to processor subsystem 180, and storage media 184 that contains settings 186 and that is communicatively coupled to processor subsystem 180, and a power source 188 electrically coupled to processor subsystem 180. Processor subsystem 180 may include any system, device, or apparatus configured to interpret and/or execute program instructions and/or process data, and may include, without limitation a microprocessor, microcontroller, digital signal processor (DSP), Application Specific Integrated Circuit (ASIC), or any other digital or analog circuitry configured to interpret and/or execute program instructions and/or process data such as an operating system 190. In some embodiments, processor 180 may interpret and/or execute program instructions and/or process data stored in memory 182 and/or another component of controller 170. Memory 182 may be communicatively coupled to processor 180 and may include any system, device, or apparatus configured to retain program instructions and/or data for a period of time (e.g., computer-readable media). By way of example without limitation, memory 182 may include RAM, EEPROM, a PCMCIA card, flash memory, magnetic storage, opto-magnetic storage, or any suitable selection and/or array of volatile or non-volatile memory that retains data after power to controller 170 is turned off or power to controller 170 is removed.

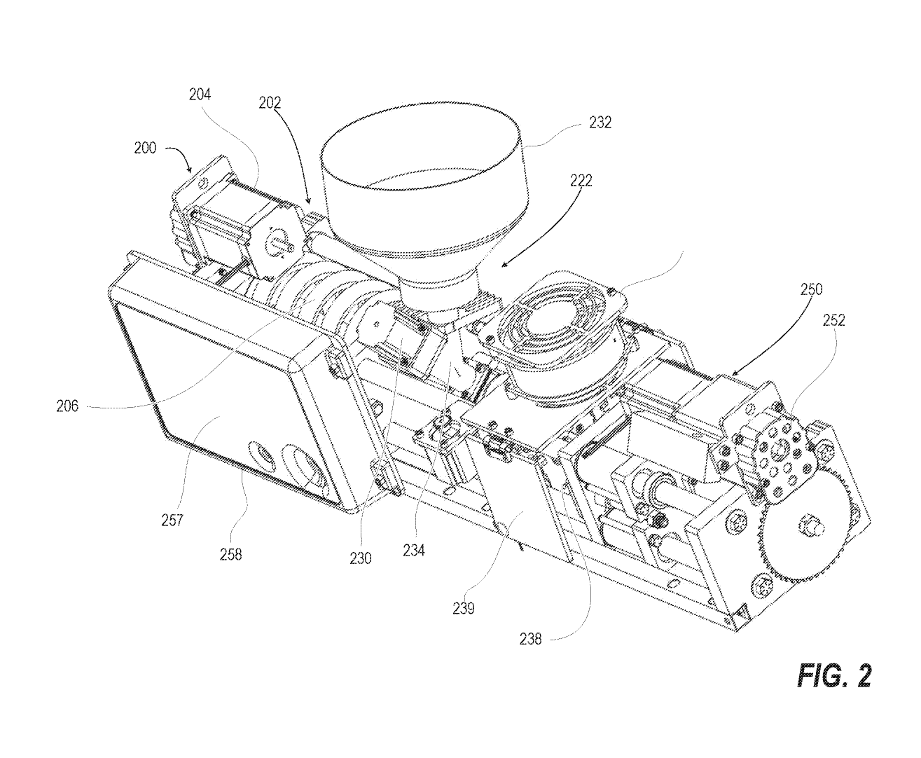

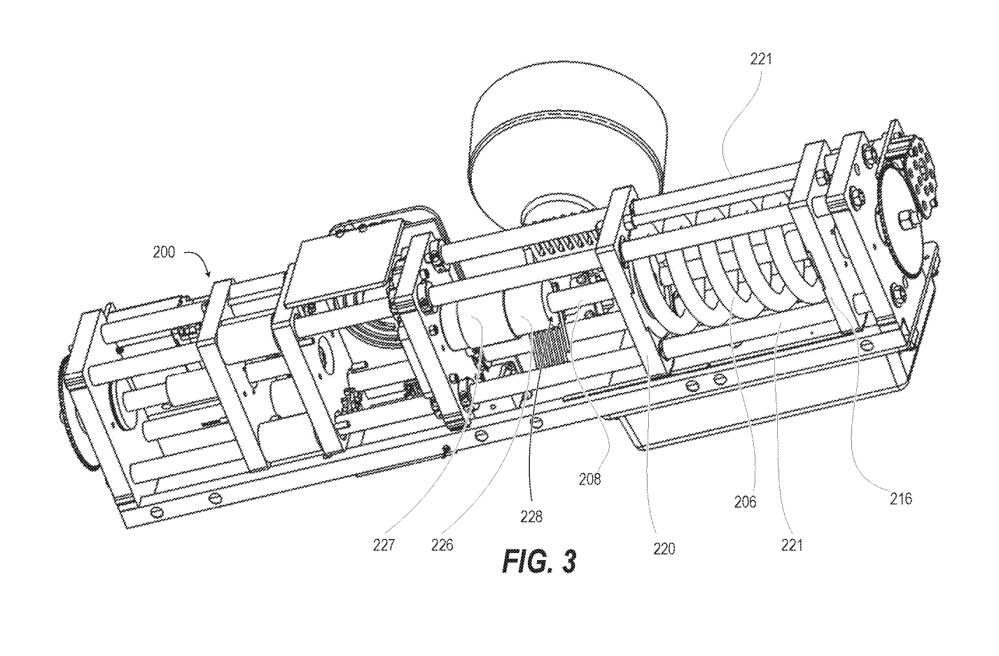

FIGS. 2-6 illustrate an example injection molding machine 200 according to one or more embodiments. FIG. 2 illustrates that a pressure-inducing injection assembly 202 is actuated by an injection motor 204 to compress a compression spring 206. FIG. 3 illustrates that the compression spring 206 acts on a plunger 208 that are constrained to move along a longitudinal axis of the injection molding machine 200 by a spring housing 112, In particular, an upstream plate 216 and a downstream plate 220 each translate along four parallel guide rods 221 that are in rectangular alignment. The plunger 208 is slidingly received within a cylinder barrel 226 a plasticizing assembly 228 that is circumferentially heated by an electric band heater 227.

Returning to FIG. 2, a pre-plasticizing assembly 222 that feeds the cylinder barrel 226 includes a hopper motor 230 that moves plastic pellets 124 (FIG. 1) from a hopper 232 through a hopper feeder 234. A mold frame 239 engageably receives a selected an injection mold kit 238 that is held shut under a clamping pressure supplied by a clamping motor 252 of a clamping assembly 250. The clamping force is aligned in opposition to the injection pressure form along the longitudinal axis of the injection molding machine 200 by four thrust cylinders 254. The injection mold kit 238 is cooled by a cooling fan module 256. A user interface assembly 257 can be provided by an electronics board panel 258.

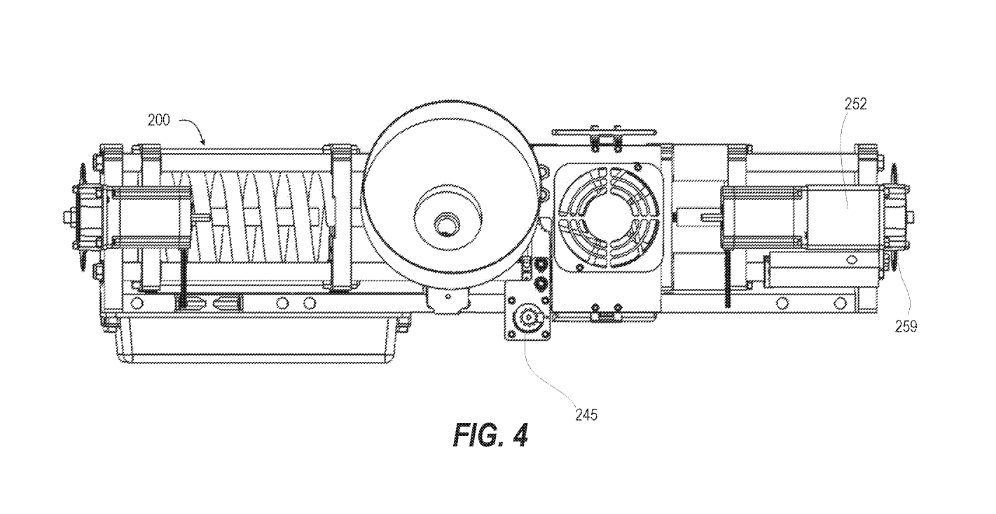

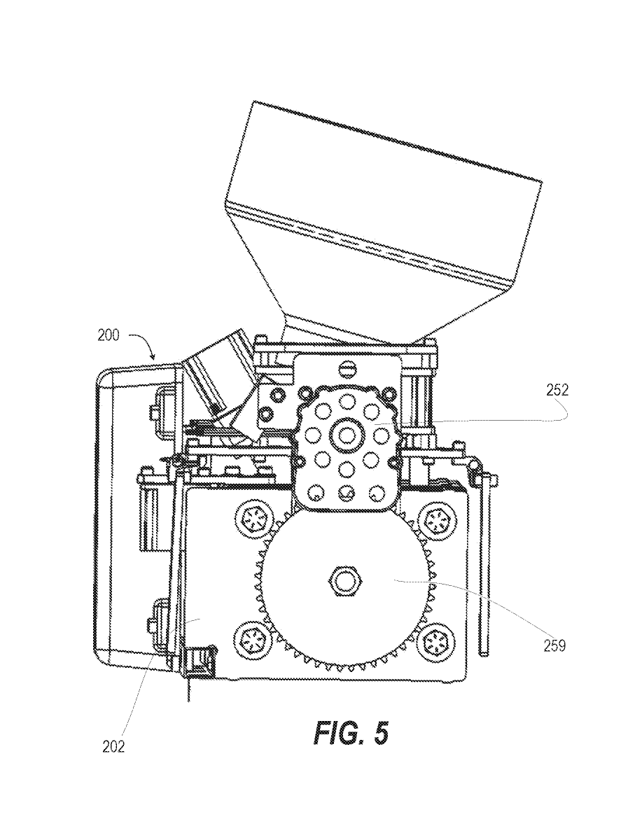

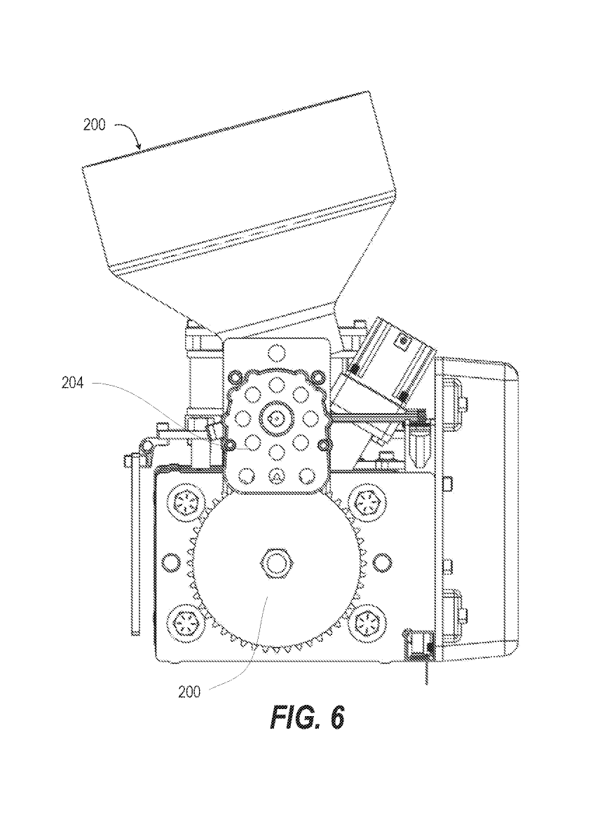

FIG. 4 illustrates a valve motor 245 that closes to allow the compression spring to build up pressure within the cylinder barrel 226 (FIG. 3). FIGS. 5-6 illustrate that the clamping motor 252 turns a large gear wheel 259 to cause longitudinal movement that acts on the mold kit 238 (FIG. 2). FIG. 6 illustrates that the injection motor 204 acts on a large gear wheel 261 to cause longitudinal movement in the pressure-inducing injection assembly 202.

The exemplary injection molding machine 200 only needs a 250 watt motor that can plug into a standard wall outlet. The exemplary injection molding machine 200 only needs a 250 watt motor that can plug into a standard wall outlet. The exemplary injection molding machine 200 uses time to build up energy over 5, 10, 15, 20 seconds or more and then releases in a short burst. Optionally, the apparatus may include a cooling mechanic and can use air or cooling fluid e.g., a water jacket on the mold that uses a separate heater/chiller unit. In one or more embodiments, the clamp assembly has eight (8) high tension springs (like washers) with two (2) per leg of the four (4) legs/locations (two (2) face each other).

Rather than requiring a large amount of instant pressure to perform the injection, the controlled valve builds up pressure at the correct rate to control till speed of plastic injected into mold. In one or more embodiments, the valve must be controlled to get proper injection rate/fill speed. In one or more embodiments, the impurities in the plastic (humidity or air usually) can be accommodated for to get better control as conventional systems generally cannot handle air gaps. In the current system, a long wait time (5, 10, 15, 20 seconds or more) before injection allows time to get the air gaps out before injection. In one or more embodiments, the Heated Cylinder further comprises one or more of: (i) Band Heater wrapped around the cylinder; (ii) Temperature probe attached to maintain about internal temperature. In one or more embodiments, the volume of the cylinder holds about 60 grams of plastic but only about 40 grams can be injected due to materials taking up space. The cylinder maintains the plastic at about 200-300 degrees C. Optionally, the apparatus can have cooling fans or cooling fins. In one or more embodiments, the; plunger is steel and, cylinder is bronze. In one or more embodiments, a copper seal is used between the heated cylinder and valve block. Generally, four bolts hold the valve block onto cylinder. In one or more embodiments, there is a heater built into the valve block to maintain the temperature of the plastic melt. In one or more embodiments, the heater is a cartridge heater having a specific watt density, based on its intended application.

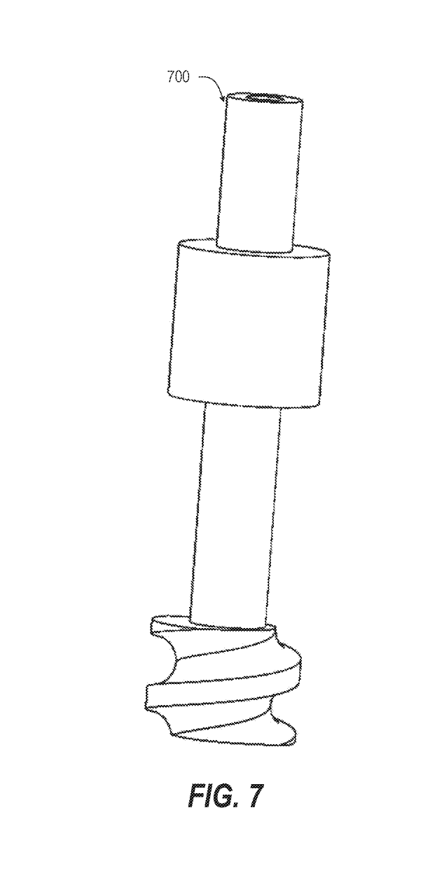

FIG. 7 illustrates a hopper screw 700 of the exemplary injection molding machine 700. Hopper screw is designed to transfer all kinds of plastic material without being jammed with the hopper 232 (FIG, 2) because of the hard plastic pellets being stuck in between. Rather than using a long screw designed to push cold plastic pellets/beads into the cylinder, which had screw turns along whole long of shaft, a new hopper screw 700 turns along the very end of the shaft so that the screw part is below the feeding tube/entry point. This avoid grinding up the pellets.

The “torpedo” element is designed to give extra heat to the mid portion of the melted plastic to prevent impurities and not being heated enough to reach mold temperature. This is an important but optional feature that works as a mixing device for the injector. The center part of the liquid plastic is colder than the outside (perimeter) plastic because the barrel is heated so heat is from outside moving in. Torpedo mixes the plastic by NOT allowing the center part to inject directly through center hole/nozzle connected to the valve. The torpedo directs the plastic to the outside through gaps that are only 0.03 inches putting the plastic very close to the barrel of the cylinder and before being directed to the center exit hole and out of the barrel. Thus, the torpedo provides for a more uniform temperature of the melted thermoplastic. Without the addition of the torpedo, the apparatus user must wait longer between cycles or clogging may occur. During continuous operation of serial injections, the apparatus may clog causing the need to wait a long time to clear an obstruction.

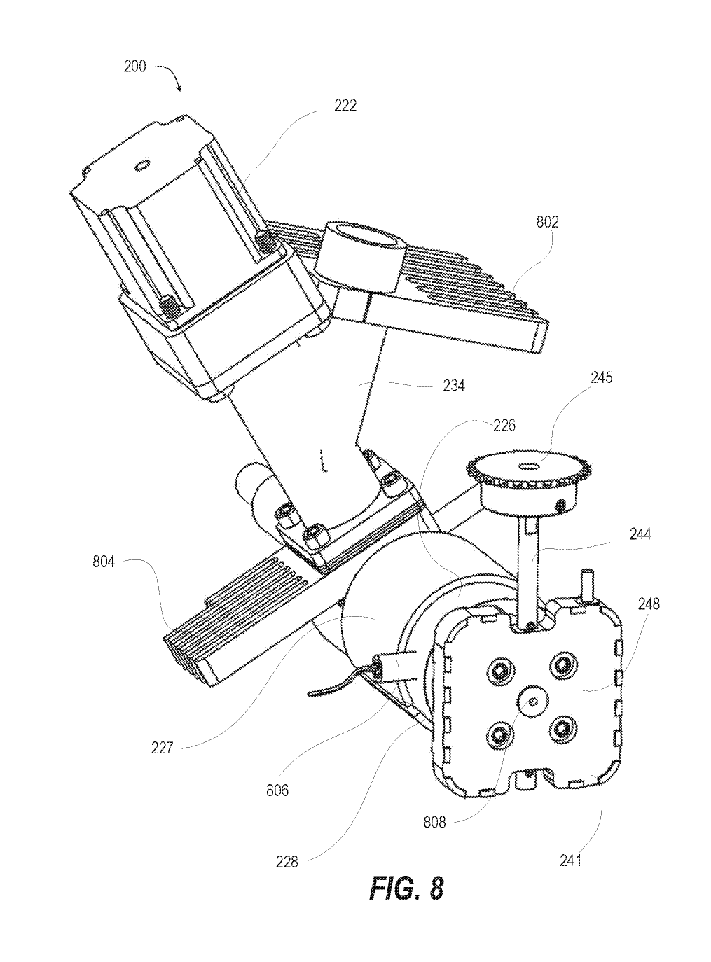

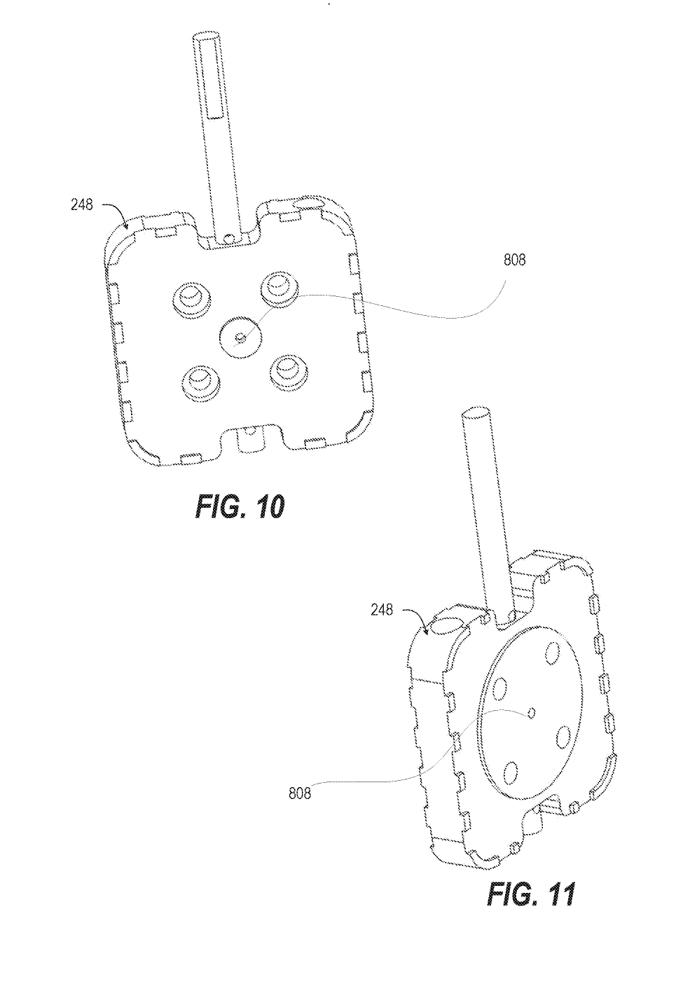

EEGs. 8-9 illustrates a plastic handling portion 800 of the injection molding machine 200 that includes the pre-plasticizing assembly 222, plasticizing assembly 228, and injection valve assembly 241. In one or more embodiments, each side of the hopper feeder 234 is cooled by cooling fins 802, 804. The cylinder barrel 226 includes a temperature sensor 806 next to the band heater 227. FIGS. 8-11 illustrate a valve metal block 248 that is selectably closed by the valve motor 245 via valve pin 244 and then opened to dispense through a nozzle 808.

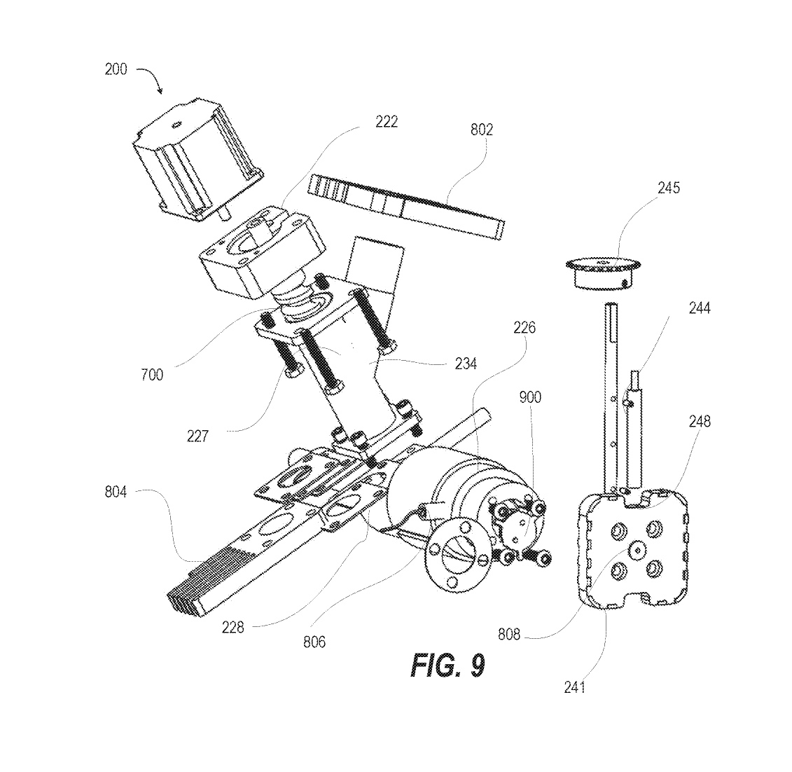

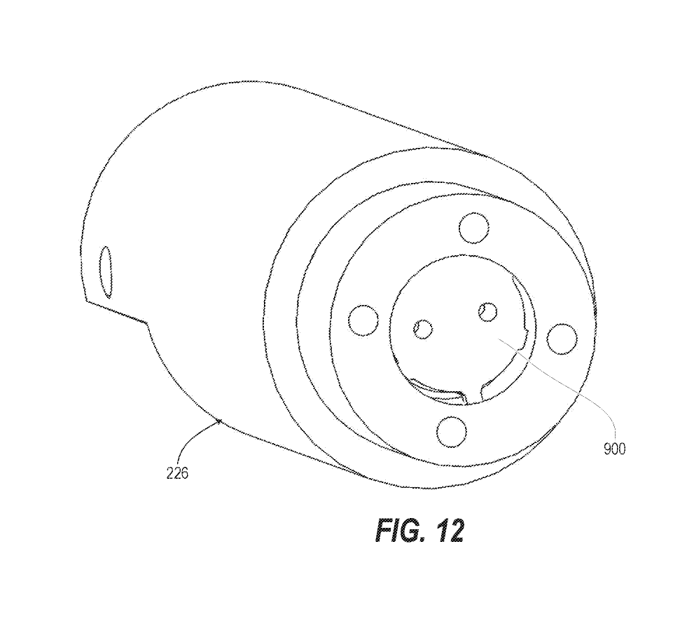

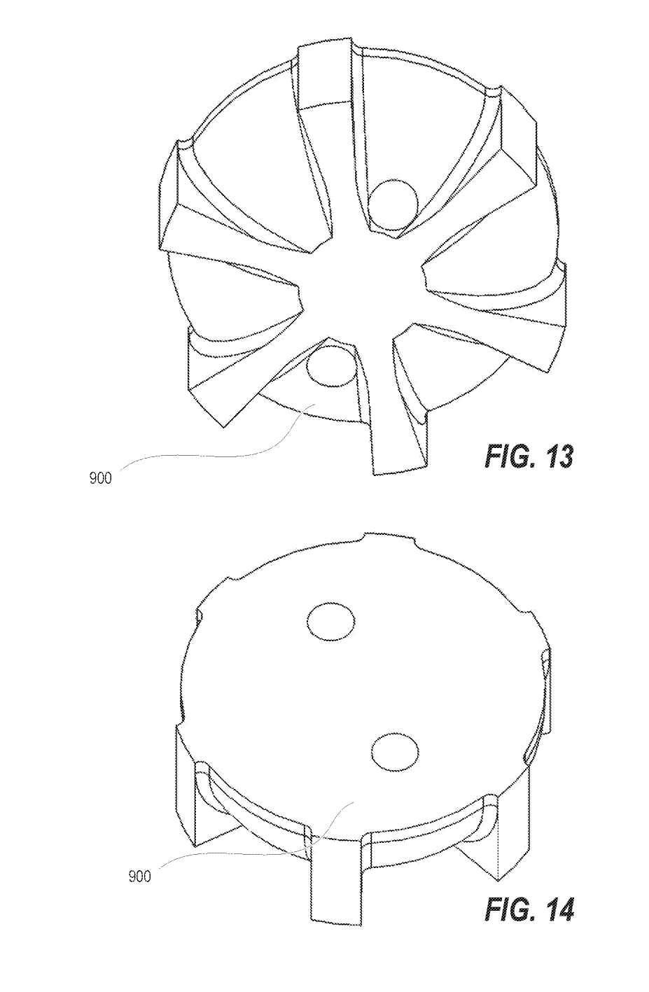

FIGS. 9 and 12-14 illustrate that a torpedo insert 900 is at dispensing end of the cylinder barrel 226 to force cooler plastic from a central portion outward closer to the heated interior surface of the cylinder barrel 226.

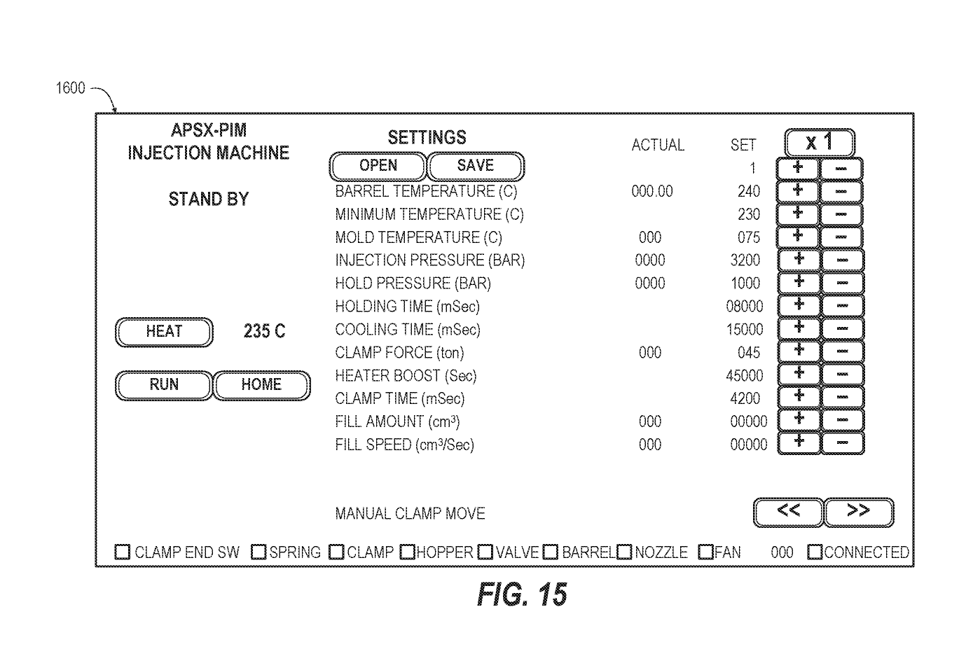

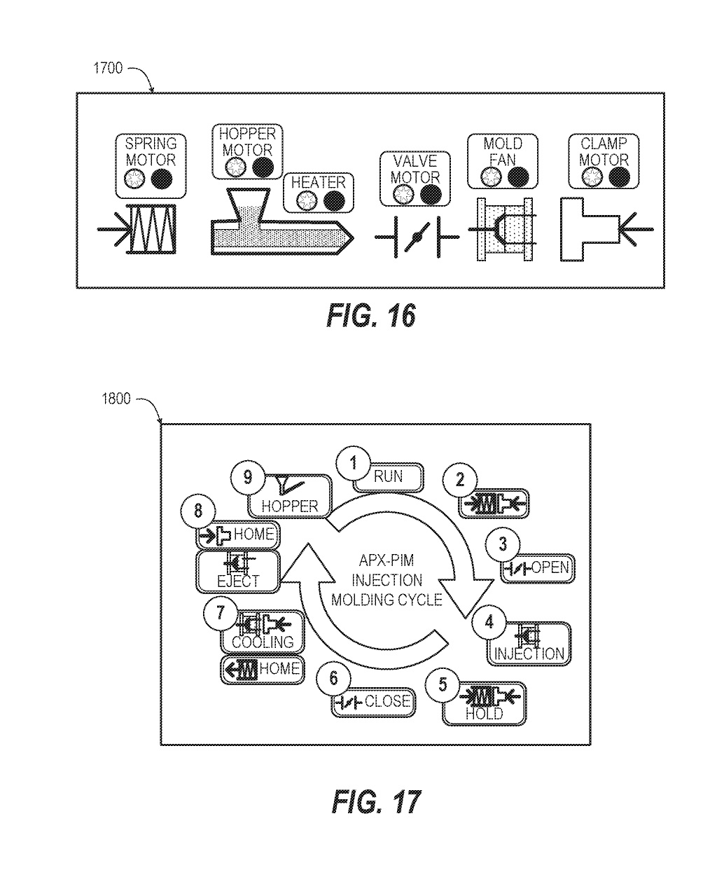

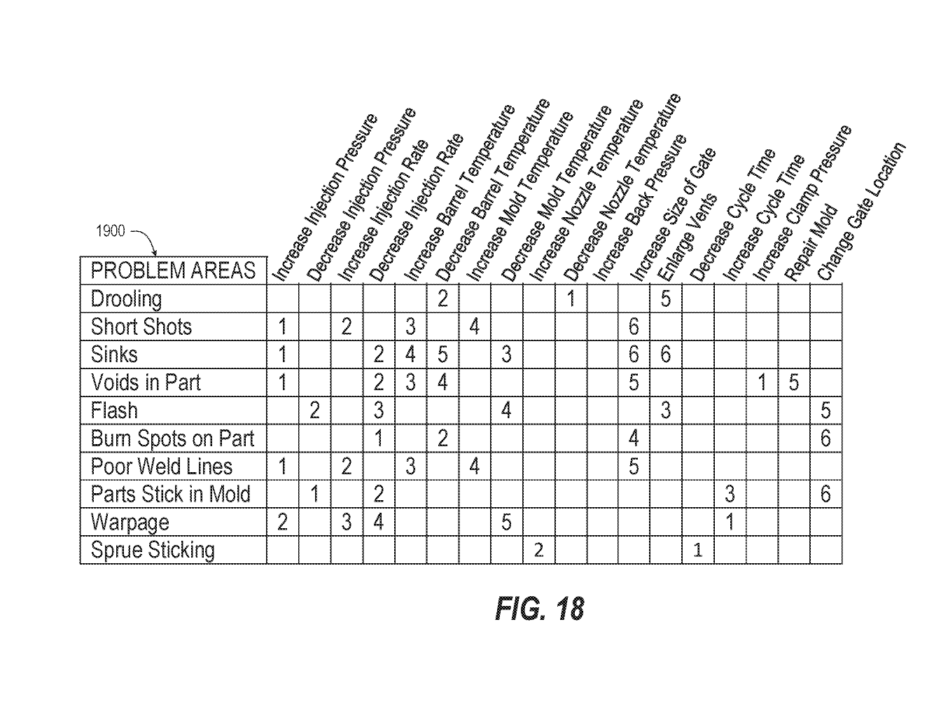

FIG. 15 illustrates a settings user interface 1500 of the of the exemplary injection molding machine 200 (FIG. 2). FIG. 16 illustrates a component status user interface 1600 of the of the exemplary injection molding machine 200 (FIG. 2). FIG. 17 illustrates a process user interface 1700 of the of the exemplary injection molding machine 200 (FIG. 2). FIG. 18 illustrates a troubleshooting user interface 1800 of the of the exemplary injection molding machine 200 (FIG. 2).

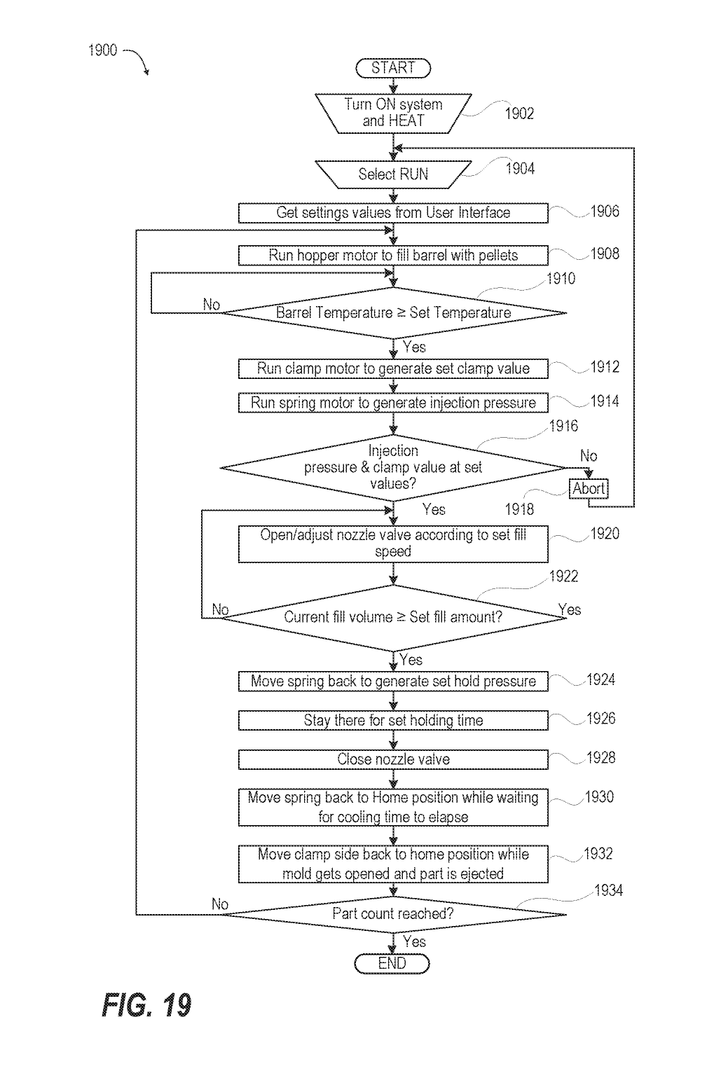

FIG. 19 illustrates a flow diagram of a method 1900 of automatically injection molding of an article. Method 1900 begins by turning on system and turning on heat (block 1902). Method includes selecting run (block 1904). The controller gets setting values from a user interface (block 1906), Method 1900 includes running a hopper motor to fill the barrel with plastic pellets (block 1908). A determination is made as to whether the barrel temperature is at least equal to the set temperature (decision block 1910). In response to determining that the barrel temperature is not at least equal to the set temperature, then method 1900 returns to block 1910 to continue heating up. In response to determining that the barrel temperature is at least equal to the set temperature, then method 1900 includes running clamp motor to generate set clamp value (block 1912). Method 1900 includes running spring motor to generate injection pressure (block 1914). A determination is made whether the injection pressure and clamp value are at set values (decision block 1916). In response to not being at the set values, method 1900 aborts and returns to block 1904 to await a new run selection. In response to reaching the set values, method 1900 includes opening/adjust nozzle value according to set fill speed (block 1920). A determination is made as to whether the current fill volume has at least reached the set fill amount (decision block 1922). In response to not reaching the set fill amount, method 1900 return to block 1920 to continue filling. In response to reaching the set fill amount, method 1900 includes moving spring back to generate set hold pressure (block 1924). The spring is held in this position for a set holding time (block 1926). Method 1900 includes closing nozzle valve (block 1928). Method 1900 includes moving clamp side back to home position while mold gets opened and part is ejected (block 1932). A determination is made as to whether the part that is ejected achieves a preset part count (decision block 1934). In response to not reaching the part count, method 1900 returns to block 1908 to injection mold more parts. In response to reaching the part count, method 1900 ends.

Molten thermoplastic material is advanced into the mold cavity until the mold cavity is substantially filled at 1922. In one or more embodiments, the terms “filled” and “full,” when used with respect to a mold cavity including thermoplastic material, are interchangeable and both terms mean that thermoplastic material has stopped flowing into the mold cavity. The mold cavity may be substantially filled when the mold cavity is more than 90% filled, preferably more than 95% filled and more preferably more than 99% filled. The term “cavity percent fill” generally refers to the percentage of the cavity that is filled on a volumetric basis. For example, if a cavity is 95% filled, then the total volume of the mold cavity that is filled is 95% of the total volumetric capacity of the mold cavity. After the mold cavity is substantially filled, the molten thermoplastic material is cooled at 1930 until the molten thermoplastic material is substantially frozen or solidified. The molten thermoplastic material may be actively cooled with a cooling liquid flowing through at least one of the first and second mold sides, or passively cooled through convection and conduction to the atmosphere.

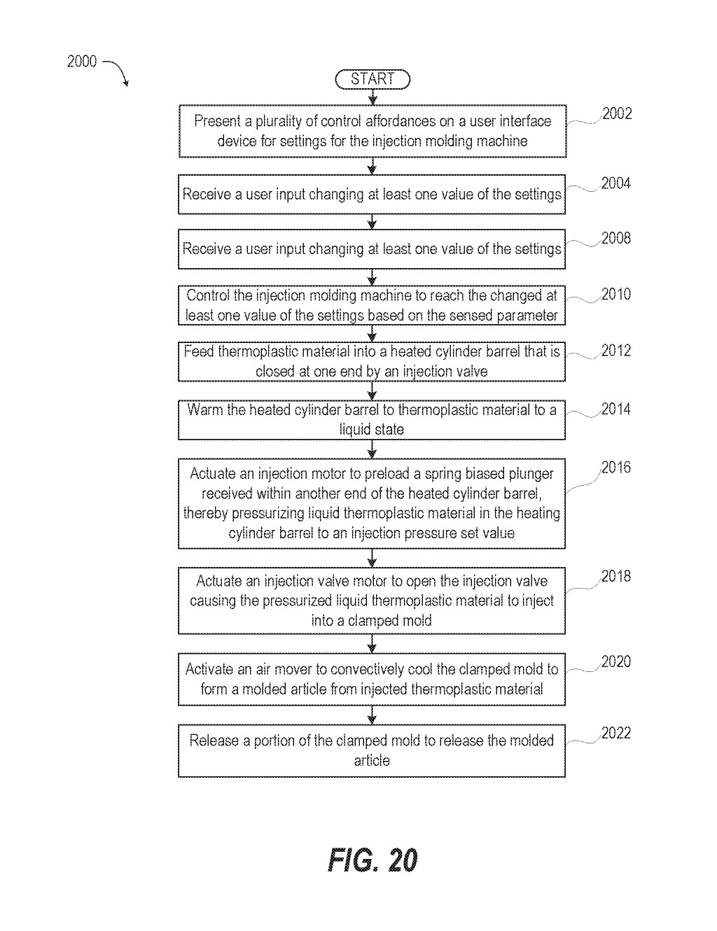

FIG. 20 illustrates an exemplary method 2000 of automatically injection molding of an article. Method 2000 includes presenting a plurality of control affordances on a user interface device for settings for the injection molding machine (block 2002). Method 2000 includes receiving a user input changing at least one value of the settings (block 2004). Method 2000 includes sensing a parameter of at least one of: (i) a temperature; (ii) a pressure; and (iii) a fluid quantity in the injection molding machine (block 2008). Method 2000 includes controlling the injection molding machine to reach the changed at least one value of the settings based on the sensed parameter (block 2010).

Method 2000 includes feeding thermoplastic material into a heated cylinder barrel that is closed at one end by an injection valve (block 2012). Method 2000 includes warming the heated cylinder barrel to thermoplastic material to a liquid state (block 2014). Method 200 includes actuating an injection motor to preload a swing biased plunger received within another end of the heated cylinder barrel, thereby pressurizing liquid thermoplastic material in the heating cylinder barrel to an injection pressure set value (block 2016). Method 2000 includes actuating an injection valve motor to open the injection valve causing the pressurized liquid thermoplastic material to inject into a clamped mold (block 2018). Method 2000 includes activating an air mover to convectively cool the clamped mold to form a molded article from injected thermoplastic material (block 2020). Method 2000 includes releasing a portion of the clamped mold to release the molded article (block 2022). Then method 2000 ends.

In the above described flow charts of FIGS. 19-20, one or more of the methods may be embodied in an automated controller that performs a series of functional processes. In some implementations, certain steps of the methods are combined, performed simultaneously or in a different order, or perhaps omitted, without deviating from the scope of the disclosure. Thus, while the method blocks are described and illustrated in a particular sequence, use of a specific sequence of functional processes represented by the blocks is not meant to imply any limitations on the disclosure. Changes may be made with regards to the sequence of processes without departing from the scope of the present disclosure. Use of a particular sequence is therefore, not to be taken in a limiting sense, and the scope of the present disclosure is defined only by the appended claims.

One or more of the embodiments of the disclosure described can be implemented, at least in part, using a software-controlled programmable processing device, such as a microprocessor, digital signal processor or other processing device, data processing apparatus or system. Thus, it is appreciated that a computer program for configuring a programmable device, apparatus or system to implement the foregoing described methods is envisaged as an aspect of the present disclosure. The computer program may be embodied as source code or undergo compilation for implementation on a processing device, apparatus, or system. Suitably, the computer program is stored on a carrier device in machine or device readable form, for example in solid-state memory, magnetic memory such as disk or tape, optically or magneto-optically readable memory such as compact disk or digital versatile disk, flash memory, etc. The processing device, apparatus or system utilizes the program or a part thereof to configure the processing device, apparatus, or system for operation.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A method of injection molding thermoplastic articles with an injection molding machine, the method comprising:
feeding thermoplastic material into a heated cylinder barrel that is closed at one end by an injection valve;
warming the heated cylinder barrel to transform thermoplastic material to a liquid state;
actuating an injection motor to preload a spring biased plunger received within another end of the heated cylinder barrel, thereby pressurizing liquid thermoplastic material in the heating cylinder barrel to an injection pressure set value;
actuating an injection valve motor to open the injection valve causing the pressurized liquid thermoplastic material to inject into a clamped mold; and
releasing a portion of the clamped mold to release the molded article.

2. The method of claim 1, further comprising:
presenting a plurality of control affordances on a user interface device for settings for the injection molding machine;
receiving a user input changing at least one value of the settings;
sensing a parameter of at least one of: (i) a temperature; (ii) a pressure; and (iii) a fluid quantity in the injection molding machine and
controlling the injection molding machine to reach the changed at least one value of the settings based on the sensed parameter.

3. The method of claim 1, further comprising activating an air mover to convectively cool the clamped mold to form a molded article from injected thermoplastic material.

4. An injection molding machine comprising:
a frame to engageably receive a replaceable two-piece core mold;
a motorized clamp assembly that selectively opens and clamps shut the two-piece cavity mold;
an electrically-controlled injection valve in fluid communication with an interior cavity defined by the two-piece mold;
heated cylinder barrel having one end in communication with the interior cavity of the two-piece mold via the injection valve;
a motorized pre-plasticizing assembly that selectively feeds solid thermoplastic material into the heated cylinder barrel;
a injection assembly comprising: (i) a plunger that is received for movement in another end of the heated cylinder barrel; (ii) a spring biasing the plunger toward the heated cylinder barrel; and (iii) an injection motor that selects moves the spring between an unbiased home position and a biased forward position to impart potential energy in the spring; and
a controller in electrical communication with the motorized clamp assembly, the heated cylinder barrel, the motorized pre-plasticizing assembly, and the injection assembly and that executes an application that configures the controller to:
feed thermoplastic material into a heated cylinder barrel that is closed at one end by an injection valve;
warm the heated cylinder barrel to thermoplastic material to a liquid state;
actuate an injection motor to preload a spring biased plunger received within another end of the heated cylinder barrel, thereby pressurizing liquid thermoplastic material in the heating cylinder barrel to an injection pressure set value;
actuate an injection valve motor to open the injection valve causing the pressurized liquid thermoplastic material to inject into a clamped mold; and
release a portion of the clamped mold to release the molded article.

5. The injection molding machine of claim 4, further comprising a user interface device, wherein the controller is in communication with the user interface device and which:
presents a plurality of control affordances on a user interface device for settings for the injection molding machine;
receives a user input changing at least one value of the settings;
senses a parameter of at least one of: (i) a temperature; (ii) a pressure; and a fluid quantity in the injection molding machine and
controls the injection molding machine to reach the changed at least one value of the settings based on the sensed parameter.

6. The injection molding machine of claim 4, further comprising an air mover positioned to direct convective cooling airflow around at least a portion of the two-piece mold, wherein the controller activates the air mover to convectively cool the clamped mold to form a molded article from injected thermoplastic material.
